(19) United States
(12) Patent Application Publication
(10) Pub. No.: US 2018/0054857 A1
(43) Pub. Date: Feb. 22, 2018

(54) RESISTANCE-HEATING METAL OR METAL ALLOY COATING

(71) Applicant: Rolls-Royce Corporation, Indianapolis, IN (US)

(72) Inventors: Quinlan Yee Shuck, Indianapolis, IN (US); Zachary D. Pebley, Zionsville, IN (US); Eric M. Bryant, Nottingham (GB); Lauren M. Miller, Bristol (GB)

(21) Appl. No.: 15/237,842

(22) Filed: Aug. 16, 2016

(51) Int. Cl. H05B 3/16; H05B 1/02; B64D 33/02; B64D 15/12

(52) U.S. Cl. CPC H05B 3/16; H05B 1/0236; B64D 33/02; B64D 2033/0233; H05B 2203/013; H05B 2214/04; B64D 15/12

(57) ABSTRACT

An article that includes a substrate, a metal or metal alloy coating on at least a portion of the substrate, and an electrically conductive lead connected to the metal or metal alloy coating, where the electrically conductive lead is configured to conduct an electric current to the metal or metal alloy coating to generate resistance heating within the metal or metal alloy coating.

### TECHNICAL FIELD

The present disclosure relates techniques for forming a metal or metal alloy coatings on articles, for example, for use in aerospace componentry.

### BACKGROUND

Aerospace components are often operated in relatively extreme environments that may expose the components to a variety of stresses and environmental factors. In some examples, the exposure of the components to the elements may result in the formation or buildup of ice on the components. The components may undergo a de-icing treatment or process to remove the ice or hinder its formation.

### SUMMARY

In some examples, the disclosure describes an article that includes a substrate, a metal or metal alloy coating on at least a portion of the substrate, and an electrically conductive lead connected to the metal or metal alloy coating, where the electrically conductive lead is configured to conduct an electric current to the metal or metal alloy coating to generate resistance heating within the metal or metal alloy coating.

In some examples, the disclosure describes a method of heating an article of an aircraft to inhibit ice formation, where the article includes a substrate, a metal or metal alloy coating on at least a portion of the substrate, and an electrically conductive lead connected to the metal or metal alloy coating, where the electrically conductive lead is configured to conduct an electric current to the metal or metal alloy coating to generate resistance heating within the metal or metal alloy coating; and the method includes causing, by a controller, a power source to apply an electric current to the metal or metal alloy coating through the electrically conductive lead to generate resistance heating within the metal or metal alloy coating that heats the metal or metal alloy coating by the resistance heating to a temperature between about 1 degree Celsius (° C.) and about 135° C.

In some examples, the disclosure describes an assembly that includes a substrate, a metal or metal alloy coating on at least a portion of the substrate, and an electrically conductive lead connected to the metal or metal alloy coating, where the electrically conductive lead is configured to conduct an electric current to the metal or metal alloy coating to generate resistance heating within the metal or metal alloy coating, and a power supply connected to the electrically conductive lead configured to supply an electrical current to the electrically conductive lead, where the assembly is installed on an aircraft

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a conceptual cross-sectional view of an example article that includes a metal or metal alloy coating applied to at least a portion of a substrate.

FIG. 2 is conceptual cross-sectional view of another example article including a substrate and a metal or metal alloy nanocrystalline coating applied to at least a portion of the substrate.

FIG. 3 is a conceptual perspective view of an example aerospace component in the form of a compressor blade that includes a polymer-based substrate coated with a metal or metal alloy nanocrystalline coating.

FIG. 4 is a flow diagram illustrating an example technique for heating an article of an aircraft to inhibit ice formation.

### DETAILED DESCRIPTION

In general, the disclosure describes aerospace articles and techniques for making aerospace articles that include a substrate having a metal or metal alloy coating applied thereto. The metal or metal alloy coating may be connected to an electrically conductive lead configured to conduct an electric current through the metal or metal alloy coating to generate resistance heating, e.g., Joule heating, within the metal or metal alloy coating. In some examples, the techniques described herein may be used to form aerospace components that exhibit improved strength and reduced weight characteristics compared to conventional titanium, steel, or other high density metal components. In some examples, the described articles may be operated in low temperature environments in which ice (e.g., water ice) formation and accumulation may occur on the article. The resistance heating of the metal or metal alloy coating may be used to heat the article to a temperature above a freezing temperature of water ice to remove ice or inhibit the formation of ice on an exterior surface of the aerospace article.

In some examples, the metal or metal alloy coating may include a nanocrystalline coating of the metal or metal alloy that defines an ultra-fine-grained crystalline microstructure with an average grain size less than about 20 nanometers (nm). In some such examples, the metal or metal alloy nanocrystalline coating may exhibit one or more of improved strength, durability, and corrosion resistance compared to alternative, non-nanocrystalline coatings of the same or similar composition. In some examples, the improved strength characteristics of the metal or metal alloy nanocrystalline coating may be experienced using a relatively thin coating (e.g., about 0.05 mm to about 0.7 mm) of the metal or metal alloy material. The relatively thin coating of the metal or metal alloy nanocrystalline material may be comparable or superior to conventional titanium, steel, or other high density metal components used to form aerospace components. Additionally or alternatively, the relative thickness and weight of the metal or metal alloy nanocrystalline coating may allow for the component to have a reduced weight compared to comparable components made from the conventional titanium, steel, or other high density metals without significantly reducing the strength characteristics of the resultant component. In some examples, the metal or metal alloy nanocrystalline coating may be applied to a lightweight substrate (e.g., polymer) to further reduce the weight of the component.

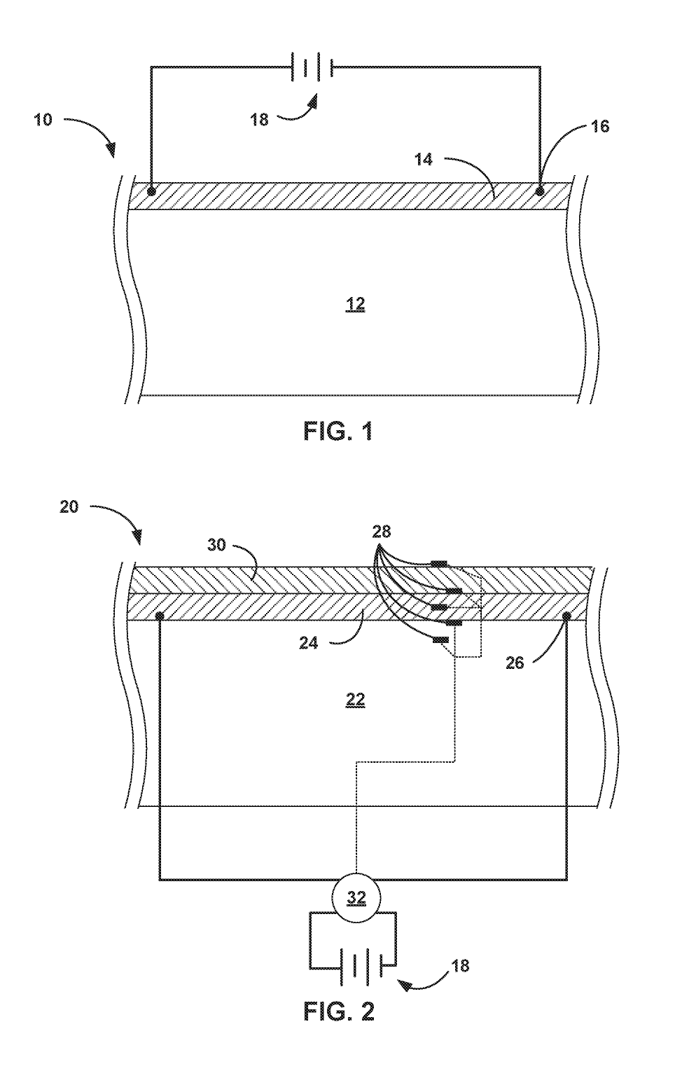

FIG. 1 is a conceptual cross-sectional view of an example article 10 that includes a metal or metal alloy coating applied to at least a portion of a substrate 12. The metal or metal alloy coating and applicable Joule heating techniques of such coatings will be described primarily with respect a metal or metal alloy that defines an ultra-fine-grained crystalline microstructure (e.g., metal or metal alloy nanocrystalline coating 14). However, it will be understood from the context of the specification that the metal or metal alloy coating and applicable Joule heating techniques of such coating may include other metal or metal alloy coatings including, for example, metal or metal alloy crystalline coatings, such as non-nanocrystalline coatings or partially nanocrystalline coatings that define grained crystalline microstructures with an average grain size greater than 20 nanometers (nm); plated metal or metal alloy coatings; and the like.

As shown in FIG. 1, article 10 includes an electrically conductive lead 16 connected to metal or metal alloy nanocrystalline coating 14 and power supply 18 configured to conduct an electric current through metal or metal alloy nanocrystalline coating 14 to generate resistance heating within metal or metal alloy nanocrystalline coating 14. The resistance heating to heat the exterior temperature of the article 10 to above the freezing point of water, which may be useful for certain types of aerospace articles including, for example, a component for a gas turbine engine such as a cold section component, an engine inlet component, a particle separator, a support structure, a bracket, a blade, a vane, or an engine casing.

In some examples, substrate 12 may include a polymeric or composite material. Examples of polymeric materials may include, for example, polyether ether ketone (PEEK), polyamide (PA), polyimide (PI), bis-maleimide (BMI), epoxy, phenolic polymers (e.g., polystyrene), polyesters, polyurethanes, silicone rubbers, copolymers, polymeric blends, and the like. Examples of composite materials may include reinforced polymeric materials. In some such examples, the reinforcement material may include, for example, fibrous material such as ceramic fibers, carbon fibers, or polymeric fibers; carbon nano-tubes; and the like. The presence of reinforcement materials in the polymeric material may increase the relative strength of the resultant substrate 12 compared to a substrate 12 that includes only polymeric material. In some examples, substrate 12 may include between about 10% to about 40% reinforcement materials (e.g., carbon fibers) mixed with one or more polymeric materials. Substrate 12 may also include one or more optional additives including, for example, binders, hardeners, plasticizers, antioxidants, and the like.

Substrate 12 may be formed using any suitable technique. For example, when forming substrate 12 using a polymeric material, substrate 12 may be formed using a mold process in which molten polymeric materials are combined with any optional additives or reinforcement materials and cast into a three-dimensional mold to form substrate 12 with the desired shape (e.g., a compressor vane). In some examples, the polymeric material may be injected into a mold containing reinforcement fibers, and the polymeric material may encase and solidify around the reinforcement fibers to form substrate 12 with the desired shape. In other examples, substrate 12 may be fabricated as a sheet/foil, which may be substantially planar (e.g., planar or nearly planar) or sculpted into a desired shape (e.g., a panel in the shape of the leading edge of an airfoil).

Article 10 includes metal or metal alloy nanocrystalline coating 14 applied to at least a portion of substrate 12. Metal or metal alloy nanocrystalline coating 14 may be formed using any suitable metals or metal alloys including, for example, cobalt, nickel, copper, iron, cobalt-based alloys, nickel-based alloys, copper-based alloys, iron-based alloys, nickel-cobalt alloys, nickel-iron alloys, or the like deposited on at least a portion of substrate 12. In some examples, metal or metal alloy nanocrystalline coating 14 may consist essentially of the metal or metal alloy, such that metal or metal alloy nanocrystalline coating 14 comprises at least 95 weight percent of the metal or metal alloy in crystalline form.

In some examples, the metal or metal alloy may be selected so that metal or metal alloy nanocrystalline coating 14 possesses an electrical resistivity between about 5.6×10⁻⁸ Ωm and about 100.0×10⁻⁸ Ωm. In some examples, the electrical resistivity of metal or metal alloy nanocrystalline coating 14 may be dependent on one or more of the geometry of article 10, current supplied to metal or metal alloy nanocrystalline coating 14, composition of metal or metal alloy nanocrystalline coating 14, or the like.

In some examples, metal or metal alloy nanocrystalline coating 14 may include one or more layers of metals or metal alloys that defines an ultra-fine-grained crystalline microstructure with an average grain size less than about 20 nanometers (nm). In some examples, the small grain size of metal or metal alloy nanocrystalline coating 14 may increase the relative tensile strength of the resultant layer as well as the overall hardness of the layer, such that metal or metal alloy nanocrystalline coating 14 may be significantly stronger and more durable compared to a conventional metallic coating (e.g., coarse grain coating) of the same composition and thickness. In some examples, the increased strength and hardness of metal or metal alloy nanocrystalline coating 14 may allow for the layer to remain relatively thin (e.g., between about 0.05 mm to about 0.7 mm) without sacrificing the desired strength and hardness characteristics of the layer. Additionally or alternatively, depositing a relatively thin layer of metal or metal alloy nanocrystalline coating 14 on substrate 12 may help reduce the overall weight of article 10 by reducing the volume of denser metals or metal alloys. The combination of the relatively light weight substrate 12 formed out of polymeric or composite materials and metal or metal alloy nanocrystalline coating 14 may result in a relatively high strength, relatively low weight article ideal for aerospace components.

The metal or metal alloy coating may be deposited on substrate 12 using suitable plating technique including, for example, electro-deposition, electroless deposition, physical vapor deposition (PVD), chemical vapor deposition (CVD), cold spraying, gas condensation, or the like to form a coated metallic layer of a desired thickness or grain size. In some examples, e.g., where ultra-fine-grained metal or metal alloy nanocrystalline coating 14 is desired, the metal or metal alloy coating may be deposited on substrate 12 using electro-deposition techniques. For example, substrate 12 may be suspended in suitable electrolyte solution that includes the selected metal or metal alloy used to form metal or metal alloy nanocrystalline coating 14. A pulsed or direct current (DC) may then be applied to substrate 12 to plate the substrate with the metal or metal alloy. In some examples, the duration of the pulsed current may be selected to obtain an ultra-fine-grained metal or metal alloy nanocrystalline coating 14 exhibiting an average grain size less than about 20 nm. In some examples, e.g., where an ultra-fine-grained metal or metal alloy coating is not desired, the metal or metal alloy coating may be formed using other deposition techniques that do not, or only partially produce an ultra-fine-grained metal or metal alloy coating.

In some such examples, substrate 12 may be initially metalized in select locations with a base layer of metal to facilitate the deposition process used to form metal or metal alloy nanocrystalline coating 14 on substrate 12 using electro-deposition. For example, a metalized base layer such as copper may be deposed on substrate 12 using electroless deposition, physical vapor deposition (PVD), chemical vapor deposition (CVD), cold spraying, gas condensation, or the like to promote adhesion between substrate 12 and metal or metal alloy nanocrystalline coating 14. In some examples, the metalized base layer may include one or more of the metals used to form metal or metal alloy nanocrystalline coating 14.

In some examples, e.g., metal or metal alloy nanocrystalline coating 14 may consist essentially of a nanocrystalline microstructure. For example, metal or metal alloy nanocrystalline coating 14 may be an entirely nanocrystalline layer apart from trace impurities within the metal or metal alloy crystalline structure.

In some examples, metal or metal alloy nanocrystalline coating 14 may be configured to exhibit improved barrier protection against erosion or corrosion compared to traditional materials used for aerospace components. For example, metal or metal alloy nanocrystalline coating 14 may include a layer of nanocrystalline cobalt. The layer of nanocrystalline cobalt or nanocrystalline cobalt-based alloy may impart anti-corrosion properties to article 10 as well as increased friction resistance and wear resistance to metal or metal alloy nanocrystalline coating 14 compared to traditional materials used for aerospace components.

Additionally or alternatively, metal or metal alloy nanocrystalline coating 14 may be configured to contribute to the durability of article 10 to resist impact damage from foreign objects during operation. For example, to improve impact damage resistance against foreign objects, aerospace components have traditionally been formed or coated with high strength metals such as titanium. Such techniques, however, may suffer from increased costs associated with processing and raw materials. Additionally, components formed from high strength metals such as titanium tend to result in relatively dense and heavy components which may be less desirable in aerospace applications. Forming article 10 to include substrate 12 and metal or metal alloy nanocrystalline coating 14 (e.g., nanocrystalline nickel or nanocrystalline nickel-based alloy) may significantly reduce the weight of the component compared to those formed with traditional high strength metals (e.g., titanium) while also obtaining comparable or even improved impact damage resistance characteristics.

In some examples, the thickness of metal or metal alloy nanocrystalline coating 14 may be between about 0.05 mm (e.g., about 0.002 inches) and about 0.7 mm (e.g., about 0.028 inches), measured in a direction substantially normal to the surface of substrate 12 on which metal or metal alloy nanocrystalline coating 14 is applied. In some examples, the thickness of metal or metal alloy nanocrystalline coating 14 may be about 0.05 mm to about 0.15 mm (e.g., about 0.002 inches to about 0.006 inches). In some examples, the overall thickness of metal or metal alloy nanocrystalline coating 14 may be selectively varied on different portions of substrate 12 to withstand various thermal and mechanical loads that article 10 may be subjected to during operation. For example, in areas where increased impact damage resistance is desired, e.g., the leading edge of a turbine blade, the relative thickness of metal or metal alloy nanocrystalline coating 14 may be increased to impart greater strength properties in that region. Additionally or alternatively, thickness of metal or metal alloy nanocrystalline coating 14 in regions where increased impact damage resistance is less desired, the thickness of the coating may be reduce.

In some examples, metal or metal alloy nanocrystalline coating 14 may include a plurality of nanocrystalline layers selectively tailored to produce a multi-layered metal or metal alloy nanocrystalline coating 14 with desired physical, chemical (e.g., corrosion resistance), and thermos-resistivity characteristics. In some examples, the relative thicknesses of the different nanocrystalline layers may be substantially the same (e.g., the same or nearly the same) or may be different depending on the composition of the respective layer and intended application of article 10.

Article 10 also includes at least one electrically conductive lead 16 electrically connected to metal or metal alloy nanocrystalline coating 14. Electrically conductive lead 16 may be configured to conduct electric current from power supply 18 to metal or metal alloy nanocrystalline coating 14 thereby causing resistive heating metal or metal alloy nanocrystalline coating 14. In some examples, the described resistance heating of metal or metal alloy nanocrystalline coating 14 may be used to remove ice (e.g., water ice) or inhibit the formation of ice on an exterior surface of article 10. For example, article 10 may be incorporated into an aircraft such as a cold stage component of a gas turbine engine that may be operated in cold weather environments where ice may form or accumulate on the exterior surface the article.

In some examples, to combat such formation of ice on articles exposed to such cold weather environments, the article may be sprayed with a chemical de-icing agent. Such de-icing agents however provide only temporary protection against the formation of ice and have undergone environmental impact scrutiny. Alternatively, in some examples, redirected exhaust from the gas turbine engine may be used to warm the article to remove and prevent the formation of ice. While the redirected exhaust may be an appropriate de-icing technique for articles composed of certain materials (e.g., steel), such techniques may not be applicable for articles constructed with a polymeric or composite based substrates such as article 10. In some such examples, the redirected exhaust may overheat the article causing the substrate to soften, warp, melt, burn, or otherwise degrade. In some examples, redirected exhaust heating may reach temperatures of about 500° F. (260° C.). Using the resistance heating, e.g., Joule heating, techniques as described herein may provide an alternative, environmentally friendly technique to de-ice specific articles of an aircraft and, in some examples, allow articles having polymeric or composite based substrates (e.g., article 10) to be incorporated into sections of an aircraft where traditional de-icing practices (e.g., redirected exhaust) may have prevented their use.

Electrically conductive lead 16 may be connected to metal or metal alloy nanocrystalline coating 14 using any suitable technique. In some examples, electrically conductive lead 16 may be attached to metal or metal alloy nanocrystalline coating 14 before, during, or after the formation of metal or metal alloy nanocrystalline coating 14. For example, in some examples electrically conductive lead 16 may be attached to an exterior surface of substrate 12 or embedded in substrate 12 prior to the formation of metal or metal alloy nanocrystalline coating 14. In some such examples, the deposition of metal or metal alloy nanocrystalline coating 14 forms the electrical connection between metal or metal alloy nanocrystalline coating 14 and electrically conductive lead 16. In some such examples, having electrically conductive lead 16 embedded in substrate 12 may help to preserve a relatively smooth exterior surface on article 10 and protect electrically conductive lead 16 (e.g., from debris or environmental damage). Additionally or alternatively, metal or metal alloy nanocrystalline coating 14 may be partially formed, followed by the application of electrically conductive lead 16 and completion of metal or metal alloy nanocrystalline coating 14 to embed electrically conductive lead 16 within metal or metal alloy nanocrystalline coating 14. Additionally or alternatively, electrically conductive lead 16 may be attached to an exterior surface of metal or metal alloy nanocrystalline coating 14 after the coating 14 has been formed.

In some examples, article 10 may include a plurality of electrically conductive leads 16 to provide redundancy in case of a lead 16 failure, to control the electrical pathway through metal or metal alloy nanocrystalline coating 14, to provide regional heating within metal or metal alloy nanocrystalline coating 14, or the like.

Electrically conductive leads 16 may be formed using any suitable materials including, for example, copper, aluminum, gold, silver, or the like. In some examples, electrically conductive leads 16 may include conductive wires such as solid or braided copper wire.

Article 10 also includes power supply 18 electrically connected to electrically conductive lead 16 and (through electrically conductive lead 16) to metal or metal alloy nanocrystalline coating 14. Power supply 18 may be supplied using any suitable device. For example, power supply 18 may be provided as part of the device in which article 10 is installed (e.g., one or more batteries installed in an aircraft). In some such examples, the current supplied by power supply 18 may be manually controlled (e.g., via a switch) by an operator to control operation and duration of the resistance heating in response to environment factors. In some examples, power supply 18 may be connected to a control device (e.g., processor) programmed to regulate the operation of power supply 18 and the resistance heating in response to different criteria such as external temperature and weather conditions; temperature of article 10, portions thereof or surrounding components; altitude; or the like.

In other examples, power supply 18 may be a device separate from article 10 and, in some example, separate from any system in which article 10 is installed (e.g., battery, generator, or the like) manually connected and disconnected by an operator.

Power supply 18 may be configured to deliver alternating current (AC), direct current (DC), or a combination of AC/DC to electrically conductive lead 16. In some examples, the current may be supplied as a continuous current, pulsed current, or the like depending on desired operational parameters. For example, power supply 18 may be configured to provide relatively large amounts of DC to metal or metal alloy nanocrystalline coating 14 on a continuous or intermittent basis to remove any accumulated ice from the surface of article 10. Some such examples may occur during the initial startup of the aircraft of while the aircraft is still on the ground. Additionally or alternatively, power supply 18 may be configured to provide relatively small amounts of AC to metal or metal alloy nanocrystalline coating 14 on a continuous or intermittent basis to inhibit the formation of ice on the exterior surface of article 10, maintain the exterior temperature of article 10 at a temperature above freezing, or both.

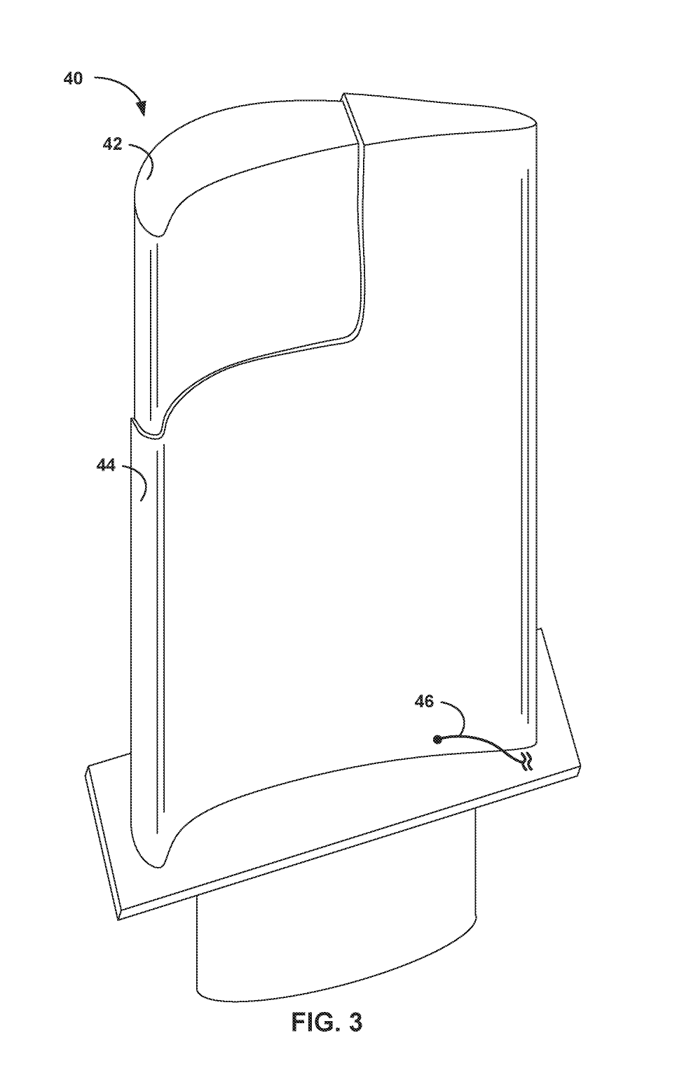

In some examples, article 10 may incorporate one or more sensors. For example, FIG. 2 is conceptual cross-sectional view of another example article 20 including substrate 22 and a metal or metal alloy nanocrystalline coating 24 applied to at least a portion of substrate 22. As described above, metal or metal alloy nanocrystalline coating may be electrically connected to power source 18 by one or more electrically conductive leads 26. Article 20 also includes one or more temperature sensors 28 configured to monitor the temperature of various parts of article 20.

For example, as shown in FIG. 2, temperature sensors 28 may be positioned at various places throughout article 20 including, for example, within substrate 22, at the interface between metal or metal alloy nanocrystalline coating 24 and substrate 22, within metal or metal alloy nanocrystalline coating 24, at an exterior surface of metal or metal alloy nanocrystalline coating 24, at an exterior or article 20, or the like. Temperature sensors 28 may be used to monitor the temperature of article 20 at the respective position of the respective sensors 28 to facilitate maintenance of the temperature of article 20 within an acceptable range (e.g., above freezing temperature of water and below the melting/softening point of substrate 22). In some examples, temperature sensors 28 may be connected to a controller 32 configured to monitor the temperature of article 20 and control power supply 18. For example, the controller 32 may control power supply 18 to discontinue provision of electrical current to metal or metal alloy nanocrystalline coating 24 (i.e., discontinue the resistance heating of metal or metal alloy nanocrystalline coating 24) in response to one or more of the temperatures sensed by temperature sensors 28 reaching a target temperature or predetermined upper limit. Additionally or alternatively, the controller 32 may be configured to control power supply 18 to activate the provision of electrical current to metal or metal alloy nanocrystalline coating 24 (i.e., activate the resistance heating of metal or metal alloy nanocrystalline coating 24) in response to one or more of the temperatures sensed by temperature sensors 28 dropping to or below predetermined lower limit (e.g., 1° C.). In some examples, one or more electrically conductive leads may be connected to temperature sensors 28 and the controller 32 to provide temperature monitoring of article 20.

In some examples, controller 32 may be a processor that includes one or more of a microprocessor, digital signal processor (DSP), application specific integrated circuits (ASIC), field programmable gate arrays (FPGA), or other digital logic circuitry.

As shown in FIG. 2, article 20 may include one or more additional coatings 30 applied to the exterior of metal or metal alloy nanocrystalline coating 24. The one or more additional coatings 30 may include, for example, an additional metal or metal alloy nanocrystalline coating, an environmental barrier coating, a thermal barrier coating, or the like. In some examples, the one or more additional coatings 30 may include an electrically insulating layer, e.g., dielectric layer, that electrically insulates metal or metal alloy nanocrystalline coating 24 from any additional layer(s) applied to article 20 or from other components adjacent to article 20. The electrically insulating layer may be used to prevent the possibility of an electrical short across metal or metal alloy nanocrystalline coating 24. In some such examples, the insulating layer may include one or more electrically insulated materials including, for example, an electrically insulating polymeric material, and electrically insulating oxide, an electrically insulating ceramic, or the like.

In some examples, one or more electrically conductive leads 26 may be formed as an integral part of substrate 22. For example, one or more electrically conductive leads 26 may be embedded in substrate 22 (e.g., during the molding process) to facilitate electrical connection with metal or metal alloy nanocrystalline coating 24 while also protecting the electrical lead from potential damage that might arise if the electrical lead 26 were positioned on an exterior surface of article 20.

In some examples, articles 10 and 20 may be in the form of an aerospace component that may benefit from one or more of the described strength characteristics, reduced weight, or resistance heating (e.g., for purposes of de-icing). In some examples, articles 10 and 20 may include aerospace components including, for example, cold section turbine engine components such as fan modules, fan blades, and the like; supports; struts; compressor section components such as vanes, blades, casings, and the like; engine inlet components; bypass components; housings members; brackets; ducts; nose cones; airfoils, flaps; casing; panels; tanks; covers; flow surfaces; particle separators; and the like. In some examples, article 10 may exhibit complex three-dimensional geometries such as a compressor blade. In other examples, article 10 may be in the form of a sheet or a shaped-sheet component used such as airfoil, air flow surface, or housing component. FIG. 3 is a conceptual perspective view of an example aerospace component 40 in the form of a compressor blade that includes a polymer-based substrate 42 coated with a metal or metal alloy nanocrystalline coating 44 electrically connected by electrically conductive lead 46 connected to a power source (not shown) configured to generate resistance heating throughout metal or metal alloy nanocrystalline coating 44.

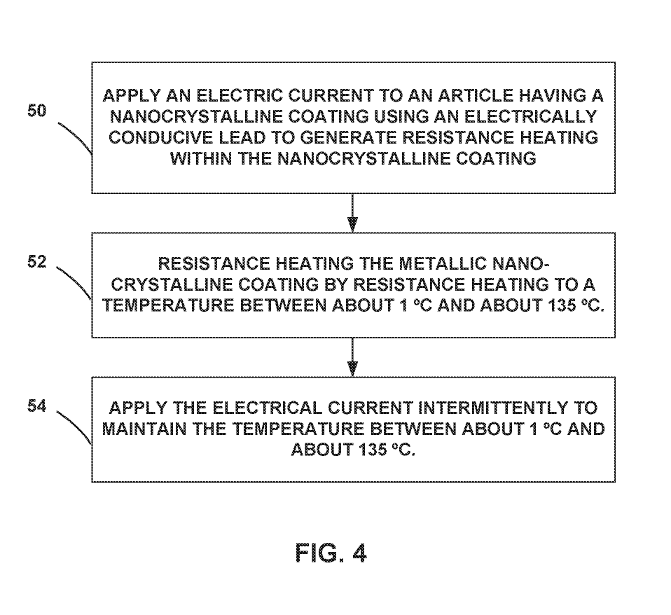

FIG. 4 is flow diagram illustrating an example technique for heating an article 10, 20, 40 of an aircraft to inhibit ice formation. While the below heating techniques of FIG. 4 are described with respect to metal or metal alloy nanocrystalline coating 14, 24, 44, it will be understood from the context of the specification that the techniques of FIG. 4 may be applied to other types of metal or metal alloy coating including, for example, metal or metal alloy crystalline coatings, such as non-nanocrystalline coatings or partially nanocrystalline coatings that define grained crystalline microstructures with an average grain size greater than 20 nanometers (nm); plated metal or metal alloy coatings; and the like; all of which are envisioned within the scope of the techniques of FIG. 4.

The technique of FIG. 4 includes applying an electric current to an article 10, 20, 40 with a metal or metal alloy coating (e.g., metal or metal alloy nanocrystalline coating 14, 24, 44) using an electrically conductive lead 16, 26, 46 to generate resistance heating within the metal or metal alloy coating (50). As describe above, article 10, 20, 40 may include a substrate 12, 22, 42 made with relatively light weight materials including, for example, polymeric materials such as PEEK, PA, PI, BMI, epoxy, phenolic polymers (e.g., polystyrene), polyesters, polyurethanes, silicone rubbers, copolymers, polymeric blends, and the like, composite materials such as fiber reinforced polymeric materials, or the like. In some examples, metal or metal alloy nanocrystalline coating 14, 24, 44 may be applied to at least a portion of substrate 12, 22, 42.

In some examples, electrically conductive lead 16, 26, 46 may include a plurality of leads to provide circuit redundancy, zoned resistant heating, direct the current flow, or the like. As described above, electrically conductive lead 16, 26, 46 may include conductive wires configured to deliver electric current from a power source 18 (e.g., a battery or generator) to metal or metal alloy nanocrystalline coating 14, 24, 44. In some examples, one or more of electrically conductive leads 16, 26, 46 may be embedded in substrate 12, 22, 42, deposited at the interface between substrate 12, 22, 42 and metal or metal alloy nanocrystalline coating 14, 24, 44, embedded in metal or metal alloy nanocrystalline coating 14, 24, 44 applied to the exterior of metal or metal alloy nanocrystalline coating 14, 24, 44, or the like.

The technique of FIG. 4 also includes resistance heating, e.g., Joule heating, the metal or metal alloy nanocrystalline coating 14, 24, 44 to a temperature between about 1° C. (e.g., above the freezing temperature of water) and about 135° C. (52) using the supplied electric current. In some examples, metal or metal alloy nanocrystalline coating 14, 24, 44 may be resistively heated to a target temperature between about 35° F. and about 50° F. (e.g., about 1.7° C. to about 10° C.).

Article 10, 20, 40 may include one or more temperature sensors 28 to provide temperature readings for various parts of article 10, 20, 40. Temperature sensors 28 may be incorporated as part of an operational system configured to maintain the temperature of article 10, 20, 40 within a target temperature range (e.g., about 1.7° C. to about 10° C.). In some examples, the one or more temperature sensors 28 may be embedded in substrate 12, 22, 42, deposited at the interface between substrate 12, 22, 42 and metal or metal alloy nanocrystalline coating 14, 24, 44, embedded in metal or metal alloy nanocrystalline coating 14, 24, 44, applied to the exterior of metal or metal alloy nanocrystalline coating 14, 24, 44, or the like.

In some examples, heating of metal or metal alloy nanocrystalline coating 14, 24, 44 by the resistance heating (52) may be controlled manually by an operator using for example an electrical switch.

In some examples, the heating of metal or metal alloy nanocrystalline coating 14, 24, 44 may be automated. For example, a controller 32 (e.g., processor or processing circuitry) may be used to supply the current to metal or metal alloy nanocrystalline coating 14, 24, 44 to heat the coating to a target temperature or temperature range (e.g., about 1.7° C. to about 10° C.). The electric current supplied from power source 18 to metal or metal alloy nanocrystalline coating 14, 24, 44 may be pulsed, intermittent, continuous, or the like and may include AC, DC, or a combination of both.

In some examples, the technique of FIG. 4 may also include an optional step of applying the electrical current intermittently to metal or metal alloy nanocrystalline coating 14, 24, 44 to a to maintain the temperature metal or metal alloy nanocrystalline coating 14, 24, 44 between about 1° C. (e.g., above freezing) and about 135° C. (52). For example, controller 32 may supply current from power source 18 to metal or metal alloy nanocrystalline coating 14, 24, 44 using one or more of electrically conductive leads 16, 26, 46 electrical leads, while monitoring one or more temperature sensors 28. Once metal or metal alloy nanocrystalline coating 14, 24, 44 reaches a target temperature or temperature range (e.g., between about 1.7° C. to about 10° C.), controller 32 may intermittently supply current to metal or metal alloy nanocrystalline coating 14, 24, 44 to maintain the temperature of the coating within the target temperature range.

In some examples, one or more of temperature sensors 28 may be associated with a safety circuit designed to discontinue the resistance heating of metal or metal alloy nanocrystalline coating 14, 24, 44 if the temperature sensed by the respective sensor exceeds a predetermined value (e.g., 135° C.) to prevent potential damage to article 10, 20, 40.

In some examples, at least some of the techniques described in this disclosure may be performed by controller 32 that implemented, at least in part, in hardware, software, firmware, or any combination thereof. For example, various aspects of the described techniques may be implemented by controller 32 that includes hardware and one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components configured to carry out the described techniques. The term “processor” or “processing circuitry” may generally refer to any of the foregoing logic circuitry, alone or in combination with other logic circuitry, or any other equivalent circuitry. Such hardware, software, and firmware of controller 32 may be implemented within the same device or within separate devices to support the various techniques described in this disclosure. In addition, any of the described units, modules or components may be implemented together or separately as discrete but interoperable logic devices.

In some examples, the techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. While the examples and techniques have been described primarily with respect to a metal or metal alloy coating that includes an nanocrystalline microstructure (e.g., metal or metal alloy nanocrystalline coating 14, 24, 44), it will be understood from the context of the disclosure that scope of the disclosure includes metal or metal alloy coatings and applicable Joule heating techniques of such coatings that may include other metal or metal alloy coatings that may not include a nanocrystalline microstructure, e.g., metal or metal alloy crystalline coatings, such as non-nanocrystalline coatings or partially nanocrystalline coatings that define grained crystalline microstructures with an average grain size greater than 20 nanometers (nm); plated metal or metal alloy coatings; and the like. These and other examples are within the scope of the following claims.

What is claimed is:

1. An article comprising:
a substrate;
a metal or metal alloy coating on at least a portion of the substrate; and
an electrically conductive lead connected to the metal or metal alloy coating, wherein the electrically conductive lead is configured to conduct an electric current to the metal or metal alloy coating to generate resistance heating within the metal or metal alloy coating.

2. The article of claim 1, wherein the substrate comprises a polymeric material.

3. The article of claim 2, wherein the polymeric material is selected from the group consisting of polyether ether ketone (PEEK), polyamide (PA), polyimide (PI), bis-maleimide (BMI), epoxy, phenolic polymers (e.g., polystyrene), polyesters, polyurethanes, silicone rubbers, and combinations thereof.

4. The article of claim 1, further comprising a temperature sensor configured to detect the temperature of at least one of the metal or metal alloy coating or substrate.

5. The article of claim 4, wherein the temperature sensor is embedded within the substrate.

6. The article of claim 1, wherein the metal or metal alloy coating is a nanocrystalline coating that defines an average grain size of less than 20 nanometers (nm).

7. The article of claim 1, further comprising an outer coating on the metal or metal alloy coating, wherein the outer coating comprises an electrically insulating material.

8. The article of claim 1, wherein the article comprises a component for a gas turbine engine selected from a group consisting of a cold section component, an engine inlet component, a particle separator, a support structure, a bracket, a blade, a vane, or an engine casing.

9. The article of claim 2, wherein the electrically conductive lead is at least partially embedded in the substrate.

10. The article of claim 1, wherein the metal or metal alloy coating comprises a thickness between about 0.05 mm and about 0.7 mm.

11. The article of claim 1, wherein the metal or metal alloy coating comprises a nickel alloy, a nickel cobalt alloy, a nickel iron alloy, or a cobalt alloy.

12. A method of heating an article of an aircraft to inhibit ice formation, wherein the article comprises:
a substrate;
a metal or metal alloy coating on at least a portion of the substrate; and
an electrically conductive lead connected to the metal or metal alloy coating, wherein the electrically conductive lead is configured to conduct an electric current to the metal or metal alloy coating to generate resistance heating within the metal or metal alloy coating, and wherein the method comprises:
causing, by a controller, a power source to apply an electric current to the metal or metal alloy coating through the electrically conductive lead to generate resistance heating within the metal or metal alloy coating that heats the metal or metal alloy coating by the resistance heating to a temperature between about 1 degree Celsius (° C.) and about 135° C.

13. The method of claim 12, wherein applying the electric current comprises intermittently causing, by the controller, the power source to apply the electric current to maintain the temperature of the metal or metal alloy coating between about 1 degree Celsius (° C.) and about 135° C.

14. The method of claim 12, wherein applying the electric current comprises causing, by the controller, the power source to apply direct current to the metal or metal alloy coating through the electrically conductive lead to resistively heat the metal or metal alloy coating to a target temperature between about 1 degree Celsius (° C.) and about 135° C.

15. The method of claim 14, wherein applying the electric current further comprises causing, by the controller, the power source to apply alternating current to the metal or metal alloy coating through the electrically conductive lead maintain the temperature of the metal or metal alloy coating within a target temperature range between about 1 degree Celsius (° C.) and about 135° C.

16. The method of claim 12, further comprising:
after reaching a predetermined maximum temperature, causing, by the controller, the power source to discontinue the electric current.

17. An assembly comprising:
a substrate;
a metal or metal alloy coating on at least a portion of the substrate;
an electrically conductive lead connected to the metal or metal alloy coating, wherein the electrically conductive lead is configured to conduct an electric current to the metal or metal alloy coating to generate resistance heating within the metal or metal alloy coating; and
a power supply connected to the electrically conductive lead configured to supply an electrical current to the electrically conductive lead; wherein the assembly is installed on an aircraft.

18. The assembly of claim 17 further comprising:
at least one temperature sensor positioned adjacent to the metal or metal alloy coating; and
a controller electrically connected to the power supply and the at least one temperature sensor, wherein the controller is configured to cause the power supply to output an electrical current to the electrically conductive lead to resistively heat the metal or metal alloy coating, and wherein when the at least one temperature sensor registers a temperature at or above a target temperature, the controller is configured to cause the power supply to discontinue the electrical current.

19. The assembly of claim 18, wherein the controller is configured to monitor a temperature measurement of the at least one temperature sensor and cause the power supply to intermittently provide and discontinue the electrical current to maintain the temperature measurement between about 1.7° C. to about 10° C. during flight of the aircraft.

20. The assembly of claim 17, wherein the power supply comprises a battery of the aircraft.
